(19) United States
(12) Patent Application Publication
(10) Pub. No.: US 2014/0189794 A1
(43) Pub. Date: Jul. 3, 2014

(54) SYSTEM AND METHOD FOR UTILIZING AND REPLACING ANONYMOUS RECOGNITION CARDS

(71) Applicant: Richard A. Ferdinand, Old Tappan, NJ (US)

(72) Inventor: Richard A. Ferdinand, Old Tappan, NJ (US)

(21) Appl. No.: 14/142,198

(22) Filed: Dec. 27, 2013

Related U.S. Application Data
(60) Provisional application No. 61/746,817, filed on Dec. 28, 2012.

(51) Int. Cl. H04L 29/06

(52) U.S. Cl. CPC H04L 63/08
USPC 726/3

(57) ABSTRACT

A system and method for utilizing and replacing an anonymous recognition substrates, which can be anonymous recognition cards, codes, emitters, tags, or any combination. The invention permits replacing and utilizing of anonymous recognition substrates at anonymous web-based program and/or at an anonymous interactive display terminals. Whereby the anonymous substrate holder may create an anonymous account on a web-based program and/or at an interactive display terminal using the anonymous substrate's anonymous code. The user may securely request a new anonymous substrate from the web-based program and/or at the interactive display terminal. The web-based program provider and/or the interactive display terminal provider can anonymously message and track the anonymous account holder and/or anonymous substrate holder.

### BACKGROUND

1. Field of the Invention

This invention relates generally to methods for replacing anonymous identification devices such as anonymous recognition cards, codes, emitters, tags, or any combination, and utilizing said anonymous identification devices in a variety ways, for example for shopping, safety measures or fun activities for the anonymous account holder and/or temporary anonymous holder. In particular, the invention relates to a system and method that provides for secure measures to replace the anonymous recognition cards and utilization of said cards in an array of situations such as to access anonymous interactive display terminals, anonymous web-based programs, advertisements, coupons, prizes, rewards, awards and safety programs.

2. Description of Related Art

The use of anonymous cards can be found at hotels, motels and resort locations. The use of anonymous cards or access cards relates to accessing different areas of the location, such as a pool, spa or dwelling room. The access cards are provided to patrons and employees for access to said areas but expire at the end of the patrons' stay or termination of the employment of employees. The replacement, distribution and access in relation the anonymous access cards are unique to each business. Most hotels that use anonymous cards suffer from certain drawbacks. For example, in order to obtain an anonymous card, the cardholder must be identified and provide personal identifiable information, such as a name, addresses, employer identification and/or credit card information.

Other uses of anonymous cards are presented at gaming facilities, such as Chuck E. Cheese or Dave and Buster's, in which the patron receives a card and can place money on it in order to access the games. A drawback is the patron can obtain as many anonymous cards as they would like and use of anonymous cards are limited to gaming, food and beverage within the respective facility. The use and level of anonymity of the cards distributed at each gaming facility is unique to that gaming facility. Some gaming facilities use the distribution of anonymous cards as the first step in later gaining personal identifying information by thereafter inducing the user to enter their loyalty program.

The use, distribution and replacement of anonymous cards is not uniform. The utilization of anonymous cards can be found in varying degrees and level of anonymity in certain industries. Accordingly, it is desirable to provide a system and method that can overcome the above-noted drawbacks. In addition, it is desirable to provide systems, methods and software for replacing anonymous cards, as well as, utilizing anonymous cards within an anonymous system that does not disclose and/or have the intention of ever obtaining the user's personal identifiable information. Furthermore, other desirable features and characteristics of the present invention will become apparent from the subsequent detailed description of the invention and the appended claims, taken in conjunction with the accompanying drawings and this background of the invention.

### SUMMARY

Systems and Methods to utilize and replace anonymous recognition cards, codes, emitters, tags, or any combination, for an anonymous user or temporary cardholder, which can be used in a variety of ways and as specifically mentioned in U.S. Provisional Application Ser. No. 61/888,596 filed on Oct. 9, 2013, entitled METHOD AND SYSTEM FOR PROVIDING ACCESS TO MULTIPLE LOCATIONS OR PROGRAMS ON ONE KEY CARD and Utility application Ser. No. 13/729,359 filed on Dec. 28, 2012, entitled GAME-BASED ADVERTISING SYSTEM AND METHOD.

A user of interactive display terminal programs and/or web-based programs can receive an anonymous recognition card to access all programs anonymously. The anonymous recognition card allows the user or temporary cardholder to interact with the system on an anonymous basis, meaning no personal information is obtained to be able to identify the user when using the card and accessing any platform or program.

Once the user receives the anonymous recognition card, the user will be able to access the display terminal with said card. An alpha numerical code, string of characters or otherwise, is on the anonymous recognition card which the user can use to sign onto to a web-based program. Once logged in the user will be prompted to create a password and user login. The user login will be anonymous and a user could not be personally identified by said user login. If the user loses or damages the anonymous recognition card, the user must simply sign on to the web-based platform to receive a new anonymous recognition card. Alternatively, the account holder can obtain a new anonymous recognition card with a new alpha numerical code, string of characters or otherwise, and link the new card to the pre-existing account by entering it in the web-based program or interactive display terminal program.

Anonymous recognition cards can be used for security and marketing purposes among others, in which the cardholder can be monitored, via sensors, readers and emitters, in real time with the location of the user or temporary card holder as they traverse the area with sensors to receive such signals. Further, capabilities of the anonymous recognition card include a “check-in” and “check-out” that can be used for security and non-security purposes. The anonymous user's data can include when and where the card is used at an interactive display terminal location or the access location to the web-based program that can be recorded in an anonymous user's database.

In accordance with the invention, the anonymous recognition cardholder may provide access codes for other members within their social circle in order to open anonymous accounts. Finally, it is also possible for the web-based and/or interactive display terminal provider(s) to modify the message and or change the display of items relating to the anonymous account holder with information about social events, coupons, prizes, awards and/or rewards, among others, when the account holder accesses a terminal or web-based program. Said message modification or changes in displays of items can be based on the data contained within the user's anonymous database.

### BRIEF DESCRIPTION OF DRAWINGS

FIG. 1 illustrates multiple embodiments of an anonymous recognition card, code, emitter or tag.

FIG. 2 shows access to a interactive display terminal and a web-based program accessed by an anonymous recognition card.

FIG. 3 depicts the activation of a web-based program.

FIG. 4 shows one embodiment of the process of replacing a lost, stolen or damaged card.

FIG. 5. depicts an anonymous gift redemption.

FIG. 6. depicts one embodiment of user data being communicated and stored in the user's anonymous database.

FIG. 7. depicts another embodiment of user data being communicated and stored in the user's anonymous database.

FIG. 8 depicts another embodiment of user data being communicated and stored in the user's anonymous database.

FIG. 9 depicts one embodiment of the dispersal of anonymous access codes.

FIG. 10 illustrates the activation of the web-based program with an anonymous access code.

FIG. 11 shows one depiction of providing a message to the anonymous account holder by the web-based and/or interactive display terminal program providers.

### LIST OF REFERENCE NUMBERS FOR THE MAJOR ELEMENTS IN THE DRAWING

The following is a list of the major elements in the drawings in numerical order.
100 anonymous recognition card
101 anonymous recognition card with anonymous code
102 anonymous code
103 anonymous recognition card
104 embedded signal emitter
105 anonymous code
106 anonymous tag
107 anonymous code
108 embedded signal emitter
109 anonymous recognition card
110 embedded signal emitter
111 magnetic strip
112 anonymous code
113 interactive display terminal
114 web-based program
115 anonymous recognition card
116 anonymous code
117 web-based program registration screen
118 anonymous code input
119 anonymous username input
120 password input
121 user's anonymous interactive compartment
122 web-based program lost card screen
123 username input
124 password input
125 lost card “click box”
126 new anonymous card
127 prior anonymous access code
128 anonymous cardholder
129 anonymous card
130 redemption provider representative
131 anonymous cardholder
132 anonymous card
133 interactive display terminal
134 interactive display terminal's data signal
135 user's anonymous database
136 anonymous cardholder
137 anonymous card
138 embedded signal emitter
139 embedded signal emitter's signal
140 interactive display terminal
141 interactive display terminal's sensor
142 interactive display terminal sensor's signal
143 interactive display terminal program data signal communication
144 user's anonymous database
145 anonymous user's mobile device
146 username input
147 password input
148 user's data communication
149 user's anonymous database
150 registered anonymous account holder
151 three un-activated anonymous codes
152 first anonymous code
153 first potentially new anonymous account holder
154 second anonymous code
155 second potentially new anonymous account holder
156 third anonymous code
157 third potentially new anonymous account holder
158 web-based program anonymous code registration screen
159 anonymous code input
160 web-based program username and password creation screen
161 anonymous username input
162 password input
163 user's anonymous interactive screen
164 user's anonymous username
165 anonymous account provider's message
166 account providers' messaging screen
167 web-based program message on account holder's screen.
168 interactive display terminal message on account holder's screen.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. Additionally, although the invention is described below as being implemented commercially, it will be appreciated that the invention can also be used for security purposes, such as identity theft or building security.

The present invention may be described in terms of functional diagrams and various processing steps. It should be appreciated that such functional diagrams may be realized in many different forms of hardware, firmware, and/or software components configured to perform the various functions. For example, the present invention may employ various processors, emitters, sensors, memory elements, digital signaling processing elements, and the like, which may carry out a variety of functions under the control of one or more microprocessors or other control devices. Such general techniques are known to those skilled in the art and are not described in detail herein. Furthermore, it should be understood that the exemplary process illustrated may include additional or fewer steps or may be performed in the context of a larger processing scheme. The various methods presented in the drawings, figures, or the specification are not to be construed as limiting the order in which individual steps may be performed. It should be appreciated that the particular implementations shown and described herein are illustrative of the invention and its best mode and are not intended to otherwise limit the scope of the invention in any way.

Provided herein are methods and systems for utilizing and replacing anonymous recognition cards, the use of the term card is inclusive of tags, or any like device or combination.

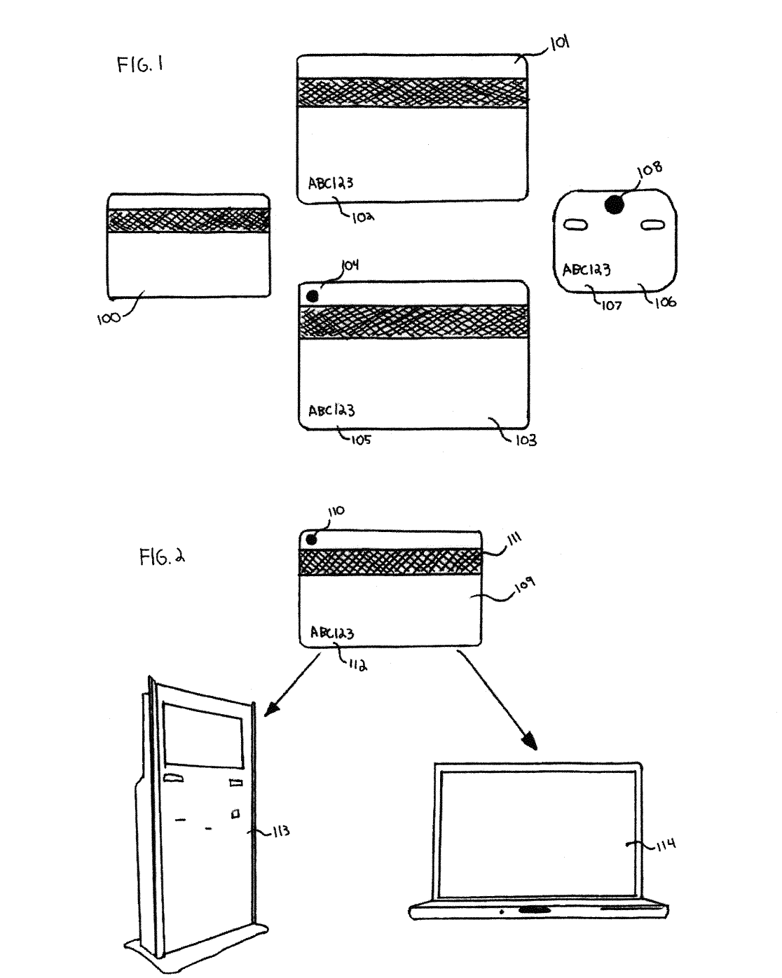

Turning now to the description, and with reference to FIG. 1, an illustration is provided of various types of anonymous recognition cards, codes, emitters, tags, or combination. The anonymous recognition card 100 is depicted with a magnetic strip that can be used to access interactive display terminals. The anonymous recognition card 101 is depicted to include an anonymous code 102 which can be used, among other things, to set up a cardholder's anonymous web-based account and a magnetic strip used to access interactive display terminals. The anonymous code 102 is depicted in an alpha-numerical fashion, but can be in any format which is possible to be input or read by a web-based provider or interactive display terminal provider. The anonymous recognition card 103 is depicted to include an embedded signal emitter 104, which emits a signal that can be accepted by a sensor or signal receptor placed in various places that can be used for anonymous tracking of the anonymous account holder and/or temporary cardholder. The anonymous recognition card 103 is also depicted to include an alpha numeric access code 105 and a magnetic strip. FIG. 1 additionally shows a tag 106 which includes an alpha-numeric anonymous code 107 and an embedded signal emitter 108.

In another embodiment not depicted, but claimed, is a tag with an embedded emitter that can be placed or interwoven into clothing such as a t-shirt or jacket that can be used for anonymous tracking purposes. Further, embodiments that are not illustrated but claimed is the replacement of a magnetic strip on the anonymous recognition card with a quick response code or any other marking that is capable of being read by interactive display terminal or web-based program, for example a 3-D image, emblem or hologram.

With reference to FIG. 2, the anonymous recognition card 109 is equipped with an embedded signal emitter 110, a magnetic strip 111 and anonymous access code 112. In this depiction the anonymous cardholder may access the interactive display terminal 113 with the magnetic strip 11. Furthermore, the cardholder may access the web-based platform 114, after setting up an account with the anonymous access code 112. As stated above, the interactive display terminal 113 and web-based platform 114 could be accessed in any way provided by said respective platforms.

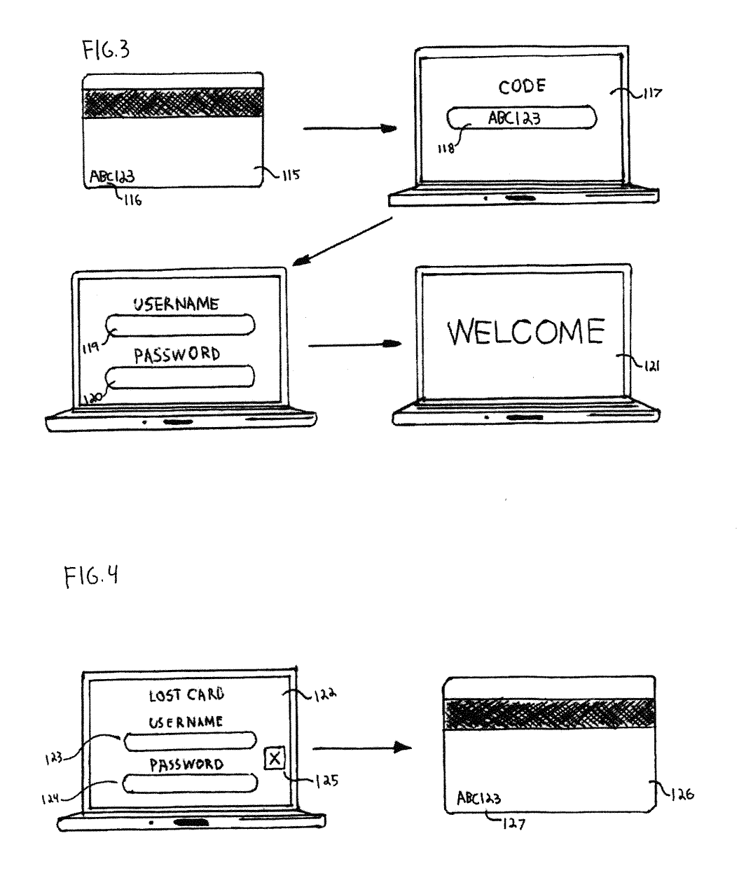

Illustrated in FIG. 3, is one embodiment of the process of setting up an anonymous web-based account. Once the cardholder has obtained an anonymous recognition card 115 that has an anonymous access code 116, the cardholder inputs the anonymous access code 116 in the input area 118 on web-based platform 117. The cardholder is then prompted to create and input an anonymous username 119 and password 120. Once the username 119 and password 120 are entered, and authenticated as unique by the anonymous program provider, the anonymous user is given access to the new web-based account holders anonymous interactive compartment 121. Not depicted, but claimed, is the ability of web-based platform providers to reject a potential username 119 that is indicative of the user's identity. Moreover, not depicted but claimed, is once the anonymous account holder enters the anonymous access code 116 into the input area 118 in order to create the account, said anonymous access code 116 will become inoperable as it relates to creating future anonymous accounts upon acceptance of the username and password by the anonymous account provider. Thus, the anonymous access code 116 can only be used and correlated in the creation of a singular account, not multiple accounts. Furthermore, the anonymous access code can be used for other purposes, for example marketing, advertising, tracking or security, in addition to being able to open a singular account. Finally, not illustrated but claimed, is the ability to accomplish the above process at the interactive terminal display as the screen can be interactive and the user is able to input the same information as on the web-based platform.

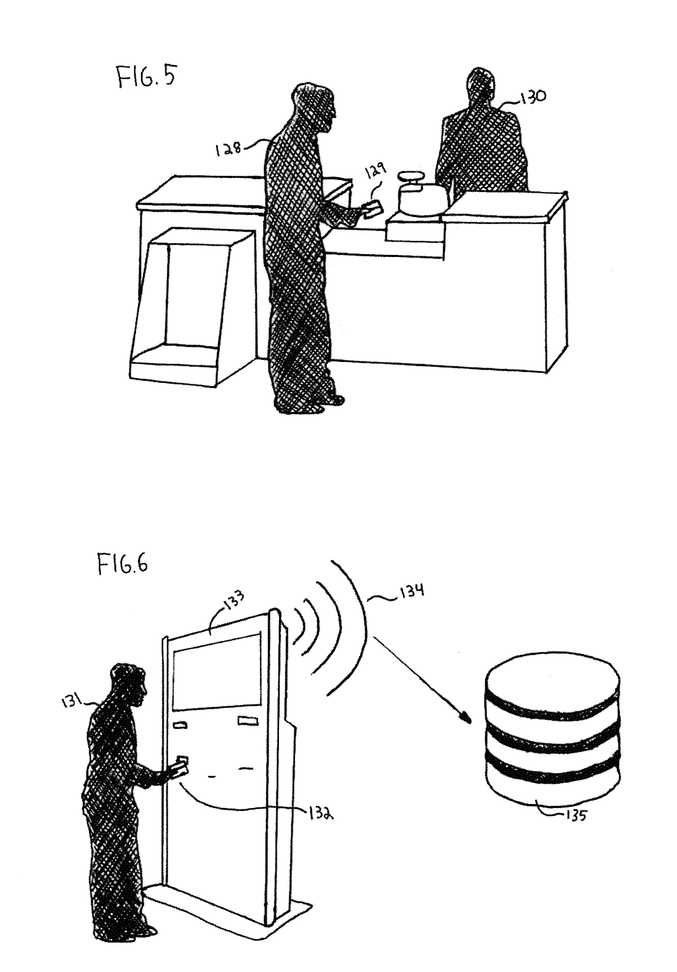

Depicted in FIG. 4, is one embodiment of the process of how an account holder can obtain a new anonymous recognition card that has been lost, stolen, damaged or otherwise misplaced. In this embodiment, the account holder has to enter the web-based platform provider's lost card screen 122 and enter the account holder's username 123 and password 124, then the user must “click” the box 125. Thereafter, the account holder will obtain a new anonymous recognition card 126 that contains the lost card's anonymous access code 127. The lost card will be de-activated upon user clicking the box 125. Not illustrated is the fashion in which the new account holder receives the new card. There are a variety of ways this can be accomplished, one such way is to go to a anonymous card providers physical location, in which the distribution of the card can be based on the verification of the anonymous user.

Not depicted, but claimed, is a process of how to obtain a new anonymous recognition card in which the account holder obtains a new anonymous recognition card from an anonymous card provider that contains a new anonymous access code, for example XYZ123. In this embodiment the user signs onto the web-based program or at the interactive terminal display and enters their anonymous interactive compartment via the username and password, then the user can enter a “lost card linking” screen in which the user enters the new anonymous code and links his account to the new code which activates the new card to the user's account. The lost card is de-activated upon the user clicking the “linking” button that establishes the link of the new anonymous code and card to the user's prior established account.

Illustrated in FIG. 5, is an anonymous account holder 128 presenting their anonymous recognition card 129 to the redemption provider representative 130 in order to redeem among other things, but not limited to, a product, prize, award, reward, coupon, discount and/or service as is related to the anonymous provider's program. Not illustrated in FIG. 5, but claimed is the redemption provider representative verifying that the proper account holder has authorized the redemption, which is achieved by having the cardholder providing the verifiable username and password of the account to the representative.

With reference to FIG. 6, the anonymous cardholder 131 uses their anonymous card 132 to access the interactive display terminal 133. As the anonymous cardholder 131 interacts with the interactive display terminal 133 their selections, choices, time spent interfacing, location and/or any possible interfacing data is sent by the physical platform, via a communications system including signal 134, to be stored in the user's anonymous database 135. Said user's anonymous database is created and maintained upon the first use and/or detection of a physical card by a interactive display terminal and/or upon the creation of an acceptable username and password on the web-based platform. The user's anonymous database can be accessed by the providers of the interactive display terminal and/or web-based platform.

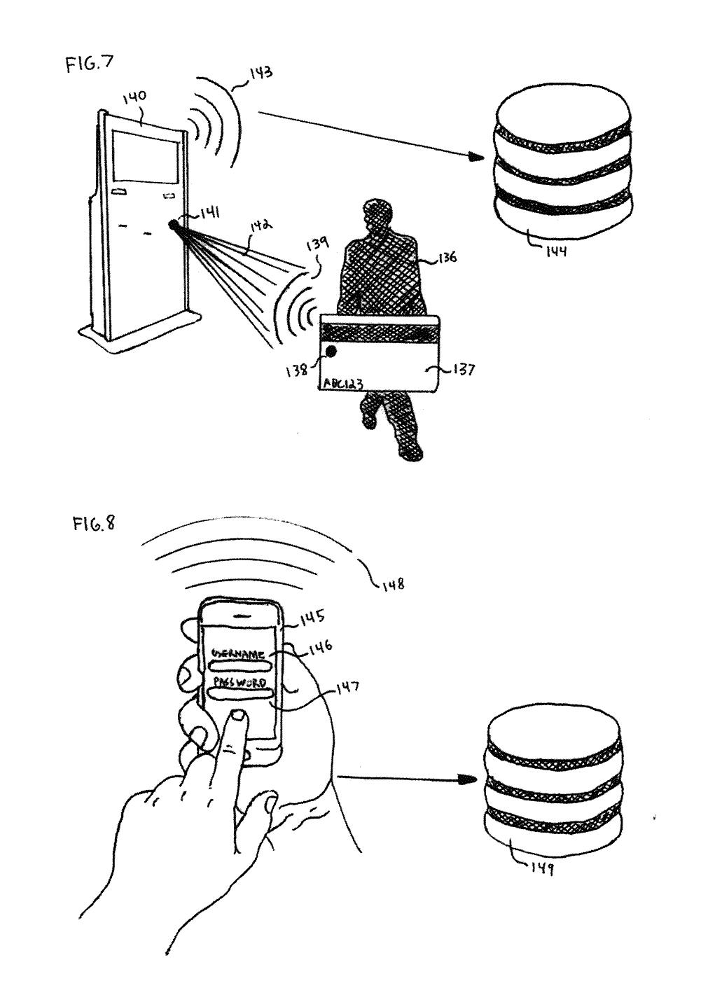

As illustrated in FIG. 7, an anonymous cardholder 136 who has an anonymous card 137 which contains an embedded signal emitter 138 that emits a signal 139 can walk by a interactive display terminal 140, without interacting with it, and be detected by the interactive display terminal sensor 141 by the sensor's signal 142. Once the embedded emitter's signal 139 is detected by the interactive display terminal sensor 141, the data associated with the detection, including but not limited to the location of the detection, the time of the detection, the duration at the location and/or any other collectable data, is then sent via communication systems within the interactive display terminal by data signal communication 143 to the user's anonymous database 144. Not illustrated but claimed is the ability to place sensors, similar to the interactive display terminal sensor 141, in other locations in which the user's data, as it relates to the detection, can be transferred to the user's anonymous database.

The web-based program can be accessed by a computer, tablet or the like, or as depicted in FIG. 8, anonymous user's mobile device 145, the user can input their username 146 and password 147 to enter the web-based platform. Upon entering the web-based program via the anonymous user's mobile device 145, the users mobile device 145 sends a data communication 148 that is stored in the user's anonymous database 149. The data contained in the data communication 148 is inclusive but not limited to the user's IP address, location, time and duration of interfacing, interfacing selections and/or choices as it relates to the web-based program provider's individual programs. Not depicted, but claimed is the data created when an anonymous user interacts and/or enters the web-based platform with their computer or tablet. Said data is again transferred and stored in the user specific database. Also not depicted but claimed is the ability to enter a user's username and password at the interactive display terminal's interactive screen in order to interact with the interactive display terminal in which the data of said interaction is sent and stored to the user specific database.

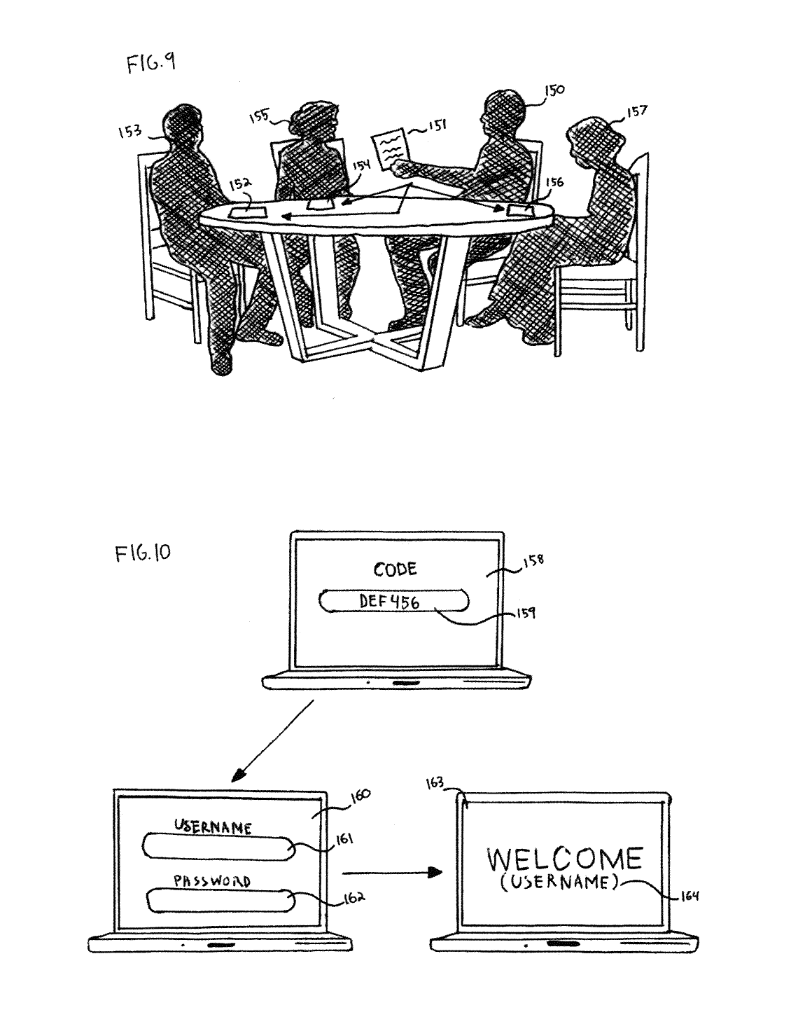

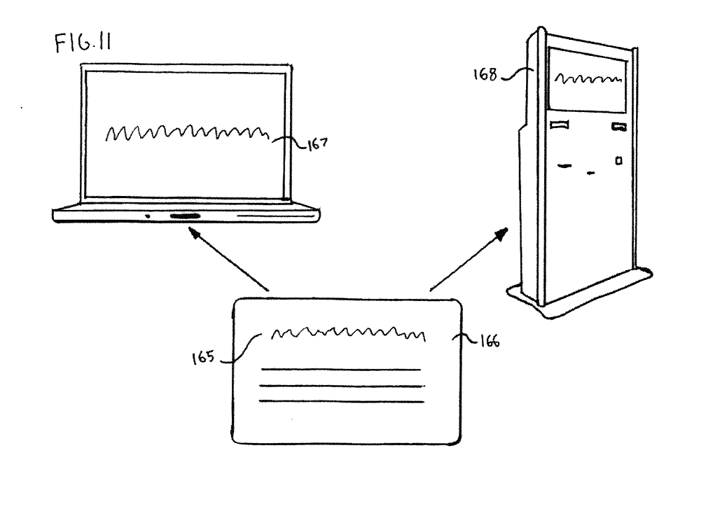

Referring to FIG. 9, a registered anonymous account holder 150 can obtain additional anonymous codes 151 for future members within and/or outside their social circle. In this illustration the three un-activated anonymous codes 152, 154, 156 can be dispersed for activation to the three potentially new anonymous account holders 153, 155, 157. As illustrated in FIG. 10, all a potentially new anonymous account holder needs to do to activate their account is go to the web-based program anonymous code registration screen 158 and input the un-activated anonymous recognition code in the anonymous code input 159. The user then enters the web-based program username and password creation screen 160 and inputs a anonymous username in the username input area 161 and a password in the password input area 162. Upon completion of a username and password, the user is directed to the user's anonymous interactive screen 163 which displays the user's anonymous username 164. Not depicted but claimed is the ability of the new user to order an anonymous recognition card which can be used at geographically dispersed interactive display terminals. Furthermore, the new user has the ability to access the interactive display terminals by inputting their username and password at the interactive display terminal's interactive screen. Finally, all data and tracking is accomplished in the same manner as stated above.

As depicted in FIG. 11, when a user enters the interactive display terminal and/or web-based program an anonymous account provider's message 165 can be sent to the user. The anonymous account provider, whether a interactive display terminal or web-based provider, may access the account provider's messaging screen 166 and input a message 165 which can be displayed to the user when the user goes to access their anonymous interactive compartment but prior to allowing access to the compartment a message will be displayed on web-based platform 167 and/or the interactive display terminal 168. Not depicted but claimed is the type of message. Said messages can be for any reason and are inclusive but not restricted to social events, coupons, prizes, awards and/or rewards. Not depicted but claimed is the ability to modify the message and/or to change the display of items on the anonymous account holders interactive compartment which can be relevant to the user based on data contained within the user's anonymous database.

1. A software program configured to enable a anonymous access code to create a anonymous account on a web-based program, wherein said anonymous access code can be a alpha-numeric code, a symbol or other code capable of being input by a user into a web-based program, said anonymous access code being limited to the creation of a singular anonymous account, said software program verifies the authenticity of said anonymous access code in a web-based program provider's database; upon verification of authenticity of said anonymous access code, the software directs a user to create a username and a password, said software program verifies the uniqueness of said username in said web-based program provider's database; upon verification of the uniqueness of said username said software program associates the anonymous access code to the username and password and stores said association in a newly created anonymous user's database then directs the user to a user's anonymous interactive compartment for user interfacing with the web-based program.

2. The software program of claim 1, wherein said software program will not allow said user to create an anonymous account if a anonymous access code can not be verified as authentic in a web-based program provider's database.

3. The software program of claim 1, wherein said software program will not allow said user to create an anonymous account if a username can not be verified as anonymous in a web-based program provider's database.

4. The software program of claim 1, wherein said software program will not allow said user to create an anonymous account if a unique username can not be verified as unique in a web-based program provider's database.

5. The software program of claim 1, wherein said anonymous access code, symbol, and other code capable of being input by a user can be utilized for other program purposes.

6. The software program of claim 1, wherein said anonymous access code, symbol, and other code capable of being input by a user is de-activated for any other purpose than opening a anonymous account.

7. A system, comprising:
a server computer having a software program within to enable a replacement of a user's anonymous recognition card, the software program including functionality that:
permits a user to request a new anonymous recognition card when the user logs into a user's anonymous program account by checking a lost card box; thereafter providing the user with a new anonymous recognition card upon verification of the proper account holder by a anonymous program provider and linking the new anonymous card to the user's anonymous program.

8. A system of claim 7, wherein the anonymous program provider provides the user with a authorization code to obtain a new anonymous recognition card at a anonymous recognition card provider location.

9. A system of claim 7, wherein the user enters a non-activated anonymous recognition card located on a non-activated anonymous recognition card and links said non-activated anonymous recognition card and number to a user's pre-existing anonymous account.

10. A method to anonymously track an account holder of an anonymous program comprising:
a. The steps of interacting with an anonymous program by a account holder;
b. storing a time and location of the interactions by a account holder with a anonymous program in a anonymous user's database;
c. identifying the occurrence of an interaction between a user's anonymous recognition card embedded emitter with a geographically placed sensor; and
d. storing a time and location of a user's anonymous recognition card embedded emitter interacting with a geographically placed sensor in a anonymous user's database.
